(19) United States
(12) Patent Application Publication
(10) Pub. No.: US 2026/0195861 A1
(43) Pub. Date: Jul. 9, 2026

(54) IMAGE PROCESSING APPARATUS AND IMAGE PROCESSING METHOD

(71) Applicant: CANON KABUSHIKI KAISHA, Tokyo (JP)

(72) Inventor: HIDEKI OGURA, Kanagawa (JP)

(21) Appl. No.: 19/422,739

(22) Filed: Dec. 17, 2025

(30) Foreign Application Priority Data
Jan. 9, 2025 (JP) 2025-003695

(51) Int. Cl. G06T 5/50; G06T 5/60; G06T 7/194; G06T 7/571

(52) U.S. Cl. CPC G06T 5/50; G06T 5/60; G06T 7/194; G06T 7/571; G06T 2207/10148; G06T 2207/20081; G06T 2207/20104; G06T 2207/20212

(57) ABSTRACT

An image processing apparatus obtains a first image shot at a first focal length, extracts a main subject region and a first background region from the first image, and creates a second image including a second background region in a case where shooting is performed at a second focal length different from the first focal length based on the first background region and distance information obtained from the first background region.

### BACKGROUND

### Field of the Technology

The present disclosure relates to a technical field in which an image having undergone a change in perspective is created.

### Description of the Related Art

Japanese Patent Laid-Open No. 2017-143354 discloses a method of performing image processing to obtain a perspective compression effect provided by a telephoto lens by detecting a main subject region and a background region from an image and synthesizing the image of the main subject and the enlarged image of the background.

Japanese Patent Laid-Open No. 2017-143354 discloses that a background region other than a main subject is detected, part of the background region is cut out and enlarged, and the images are synthesized in a state in which the positional relationship between the center of the main subject region and that of the background region is held. However, this cannot create an image having undergone a change in perspective concerning the main subject region and the background region.

### SUMMARY

The present disclosure has been made in consideration of the aforementioned problems, and provides technical advantages in creating an image having undergone a change in perspective concerning a main subject region and a background region.

In order to solve the aforementioned problems, the present disclosure is directed to an image processing apparatus comprising: an obtaining unit that obtains a first image shot at a first focal length; an extraction unit that extracts a main subject region and a first background region from the first image; and a creating unit that creates a second image including a second background region in a case where shooting is performed at a second focal length different from the first focal length based on the first background region and distance information obtained from the first background region.

According to the present disclosure, it is possible to create an image having undergone a change in perspective concerning a main subject region and a background region.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view showing a system configuration according to a present embodiment;

FIG. 2 is a block diagram exemplarily showing the hardware configuration of an image processing apparatus according to the present embodiment;

FIG. 3 is a block diagram exemplarily showing the functional configuration of a system according to the present embodiment;

FIGS. 4A to 4C are views for explaining the perspectives of images according to the present embodiment;

FIGS. 5A and 5B are views exemplarily showing images with different perspectives according to the present embodiment;

FIG. 6 is a flowchart exemplarily showing image creation processing according to the present embodiment;

FIG. 7 is a view for explaining learning processing according to the present embodiment;

FIG. 8 is a view exemplarily showing a UI for changing the focal length setting according to the present embodiment;

FIG. 9 is a view exemplarily showing an image with a short focal length and enhanced perspective according to the present embodiment;

FIG. 10 is a view exemplarily showing an image with a long focal length and reduced perspective according to the present embodiment;

FIG. 11 is a view for explaining a method of selecting a main subject region according to the present embodiment;

FIG. 12 is a view exemplarily showing a defocus map according to the present embodiment; and

FIG. 13 is a view exemplarily showing a method of extracting background regions according to the present embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### SYSTEM CONFIGURATION

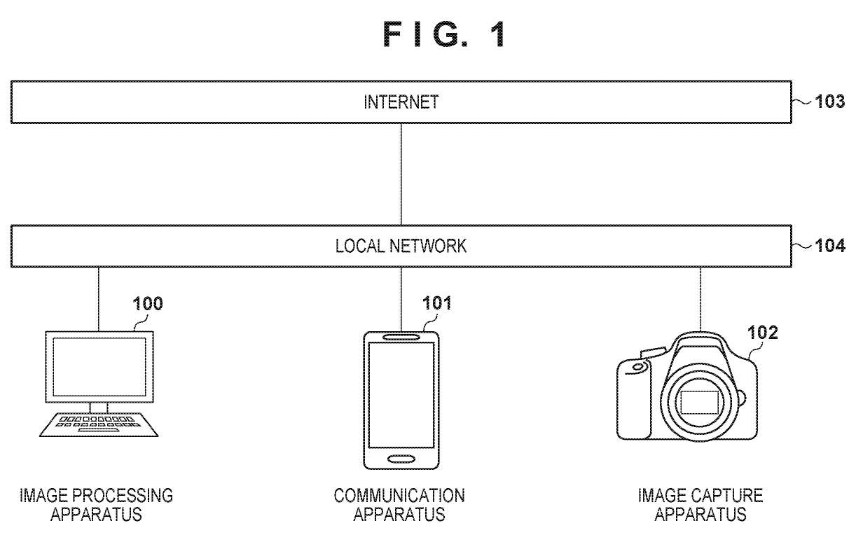

A system configuration according to a present embodiment will be described first with reference to FIG. 1.

A system 1 according to the present embodiment includes an image processing apparatus 100, a communication apparatus 101, an image capture apparatus 102, the Internet 103, and a local network 104.

The image processing apparatus 100 is one of client terminals such as a computer apparatus and performs addition, display, and learning/inference of image data.

The communication apparatus 101 is one of client terminals such as a smartphone and implements instructions to perform selection, display, and learning/inference of image data by using an application 311 (to be described later).

The image capture apparatus 102 is one of client terminals such as a digital camera and uploads image data to the image processing apparatus 100.

The local network 104 is a network to which client terminals such as the image processing apparatus 100, the communication apparatus 101, and the image capture apparatus 102 are connected. These client terminals can mutually communicate with each other via the local network 104.

The Internet 103 is a network to which the local network 104 is connected. The devices connected to the local network 104 can mutually communicate with each other via the Internet 103.

### HARDWARE CONFIGURATION

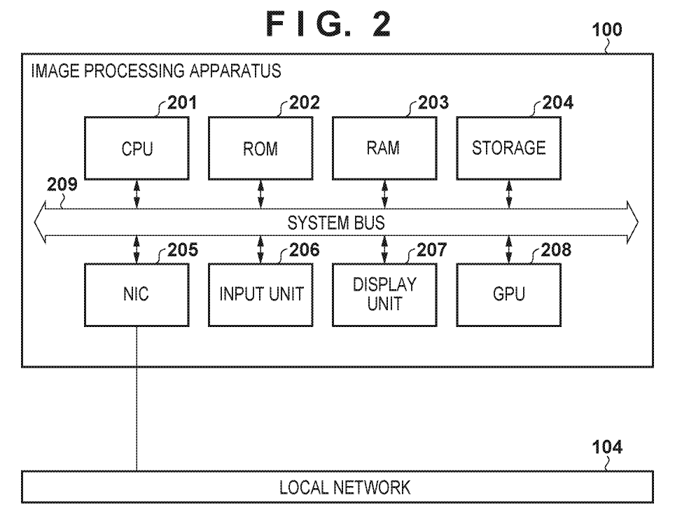

The hardware configuration of the image processing apparatus according to the present embodiment will be described next with reference to FIG. 2.

FIG. 2 is a view for explaining the hardware configuration of the image processing apparatus 100 constituting part of the system shown in FIG. 1.

FIG. 2 shows only the image processing apparatus 100 and the local network 104 of the system shown in FIG. 1 while omitting the illustration of other components.

The image processing apparatus 100 includes a CPU 201, a ROM 202, a RAM 203, a storage 204, a network interface controller (NIC) 205, an input unit 206, a display unit 207, and a GPU 208. These components are connected to each other via a system bus 209 so as to exchange data.

The CPU 201 is a control unit that controls the operation of the image processing apparatus 100. The CPU 201 controls each component (to be described later) and performs operations corresponding to the data input from the input unit 206 and the data received from the NIC 205.

The ROM 202 is a nonvolatile memory and stores programs that control the image processing apparatus 100. When the power supply of the image processing apparatus 100 is turned on, the CPU 201 loads a program from the ROM 202 and starts to control the image processing apparatus 100. The ROM 202 is, for example, a nonvolatile memory such as a flash memory.

The RAM 203 is a rewritable memory and used as a work area by a program that controls the image processing apparatus 100. As the RAM 203, for example, a volatile memory (DRAM) using a semiconductor element is used.

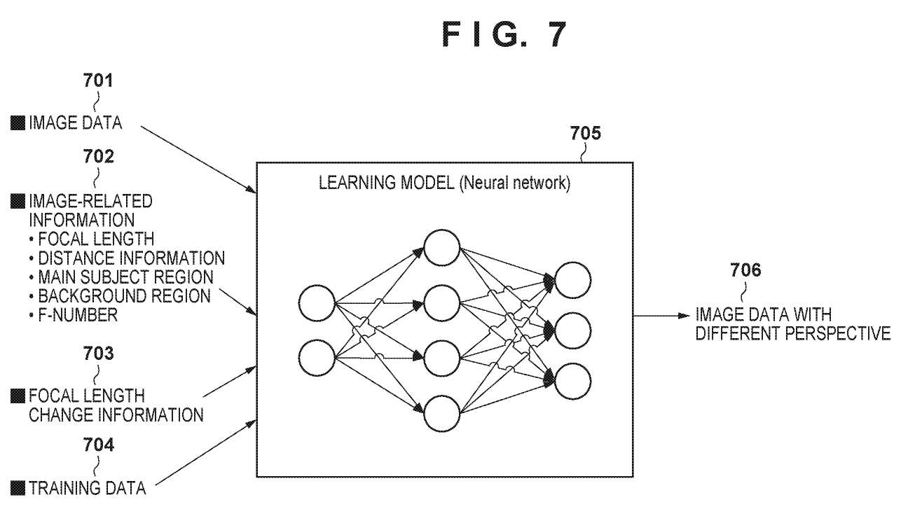

The storage 204 is a large-capacity storage unit that stores the image data created by the CPU 201 and the image data obtained by learning with a learning model 705 (FIG. 7) (to be described later). The storage 204 is, for example, a hard disk drive (HDD) using a magnetic storage scheme or a solid-state drive (SSD) using a semiconductor element.

The NIC 205 is used by the image processing apparatus 100 to communicate with other apparatuses via the local network 104. As the NIC 205, for example, a communication scheme complying with Ethernet^{®} or IEEE 802.3 is used.

The input unit 206 is used by the user of the image processing apparatus 100 to operate the image processing apparatus 100. The input unit 206 is, for example, an input device such as a keyboard or mouse. In the present embodiment, the user inputs an instruction to execute learning processing or inference processing (to be described later) via the input unit 206 of the image processing apparatus 100.

The display unit 207 is used to display the operation state of the image processing apparatus 100. The display unit 207 is, for example, a display device such as a liquid crystal display or organic EL display. Note that the image processing apparatus 100 according to the present embodiment can be a form from which the display unit 207 is omitted.

The GPU 208 is a processor that performs parallel arithmetic processing of data. The GPU 208 can perform efficient arithmetic processing by performing parallel arithmetic processing of more data and hence is effective in a case where learning processing is performed a plurality of times by using a learning model, such as deep learning, or a case where many product-of-sum operations are performed in inference processing. Although, as the GPU 208, an LSI called a graphics processing unit is used, a similar function may be implemented by a reconfigurable logic circuit called an FPGA.

### SOFTWARE CONFIGURATION

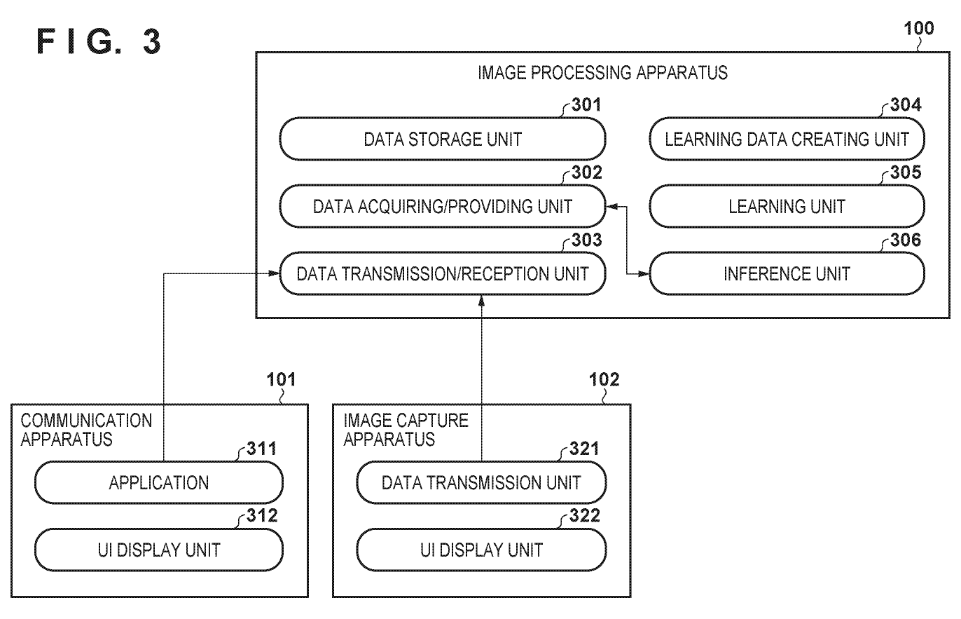

The functional configuration of the system according to the present embodiment will be described next with reference to FIG. 3.

The functional configuration of the image processing apparatus 100 according to the present embodiment is implemented by using the hardware resource described with reference to FIG. 2 and programs. Note that the functional configuration of the present embodiment is the one from which a general-purpose software configuration such as an operating system is omitted. The functional configuration of the image processing apparatus 100 includes a data storage unit 301, a data acquiring/providing unit 302, a data transmission/reception unit 303, a learning data creating unit 304, a learning unit 305, and an inference unit 306.

The data storage unit 301 has functions of storing image data and for searching and managing the stored image data. For image data storage, the image data obtained by using the data transmission/reception unit 303 is stored in the storage 204. For image data management, meta data of the image data obtained by the data acquiring/providing unit 302 - such as focal length, shooting distance, F-number, defocus map, shooting date and time, camera information, shooting location (e.g., GPS latitude/longitude), and distance information measured by a distance sensor such as LiDAR (Light Detection And Ranging), including distances to the main subject and backgrounds) - is stored in association with the image data in the storage 204. In order to implement the functions of the data storage unit 301, database software may be installed in the data storage unit 301.

The data storage unit 301 also has a function of storing image data used by the learning unit 305 for learning processing, image data used by the inference unit 306 for inference processing, and the learning model 705 obtained by learning processing. The image data used for learning is processed by the learning data creating unit 304 and stored in the storage 204. The learning model 705 created by the learning unit 305 is also stored in the storage 204 by the data storage unit 301. Likewise, in a case where the inference unit 306 creates image data with different perspective, the data storage unit 301 obtains the learning model 705 from the storage 204. The creation of images of background regions will be described later with reference to the flowchart of FIG. 6.

The data acquiring/providing unit 302 has a function of transmitting image data to the inference unit 306 and obtaining image data with perspective different from that of the transmitted original image data from the inference unit 306. The data acquiring/providing unit 302 obtains image data from the data storage unit 301, performs preprocessing such as reduction/bit count reduction on the image data by using the CPU 201, and then transmits the preprocessed data to the inference unit 306. The data acquiring/providing unit 302 then receives the image data that is created by the inference unit 306 so as to have different perspective. The CPU 201 analyzes the image data with the different perspective and stores it in the data storage unit 301 while associating the original image data with the image data with the different perspective.

The data transmission/reception unit 303 has a function of transmitting and receiving data to and from client terminals such as the communication apparatus 101 and the image capture apparatus 102. Upon receiving a request to upload image data from the communication apparatus 101 or the image capture apparatus 102 via the NIC 205, the data transmission/reception unit 303 stores the received image data in the data storage unit 301. Upon receiving a request to search or obtain image data from the communication apparatus 101 or the image capture apparatus 102, the data transmission/reception unit 303 obtains the requested image data or information of the image data from the data storage unit 301 and acknowledges the request source via the NIC 205. In order to implement the function of the data transmission/reception unit 303, Web server software may be installed in the data transmission/reception unit 303.

The learning data creating unit 304 has a function of performing preprocessing (reduction, rotation, bit reduction, and the like) on learning image data when performing learning processing on the learning model 705. The learning data creating unit 304 associates input data (image data) for learning with training data (image data with different perspective) corresponding to the input data. Note that the present embodiment may be configured to provide input data for learning and training data to be associated with the input data from an external apparatus (not shown).

The learning unit 305 has a function of performing learning processing by using input data for learning which is preprocessed by the learning data creating unit 304 and training data associated with the input data and updating the learning model 705 stored in the storage 204. Since the learning processing performed by the learning unit 305 is implemented by performing parallel processing on many data, the present embodiment uses the GPU 208 in addition to the CPU 201 for the learning processing by the learning unit 305. More specifically, in executing a learning program including a learning model, the CPU 201 and the GPU 208 operate in corporation with each other to perform arithmetic processing, thereby performing learning. Note that in learning processing by the learning unit 305, either the CPU 201 or the GPU 208 may perform arithmetic processing.

The inference unit 306 has a function of creating image data with different perspective from the image data provided from a client terminal or the like by performing inference processing using the learning model 705 stored by the data storage unit 301 in the storage 204. The inference processing performed by the inference unit 306 is implemented by performing parallel processing on many data. Accordingly, in the inference processing performed by the inference unit 306, the present embodiment uses the GPU 208 in addition to the CPU 201. More specifically, in executing a learning program including a learning model, the CPU 201 and the GPU 208 perform arithmetic processing in cooperation with each other to perform inference processing. Note that in the inference processing performed by the inference unit 306, only the CPU 201 and the GPU 208 may perform arithmetic processing.

The software in the communication apparatus 101 includes the application 311 and a user interface (UI) display unit 312.

The application 311 has a function of transmitting image data held by the communication apparatus 101 to the data transmission/reception unit 303 of the image processing apparatus 100. The application 311 also has a function of processing and displaying the image data obtained from the data transmission/reception unit 303 of the image processing apparatus 100 so as to allow the user of the communication apparatus 101 to visually recognize the image data. The application 311 also has a function of communicating information to the data transmission/reception unit 303 of the image processing apparatus 100 by using the learning model 705 in accordance with a user operation.

The UI display unit 312 has a function of providing a user interface for displaying arbitrary image data of the image data held by the communication apparatus 101 so as to allow the user to select the displayed data.

The software in the image capture apparatus 102 includes a data transmission unit 321 and a UI display unit 322.

The data transmission unit 321 has a function of transmitting, to the data transmission/reception unit 303, the image data included in the image data held by the image capture apparatus 102 and selected by the UI display unit 322.

The UI display unit 322 has a function of providing a user interface for displaying arbitrary image data of the image data held by the image capture apparatus 102 so as to allow the user to select the arbitrary image data.

### DESCRIPTION OF PERSPECTIVE OF IMAGE

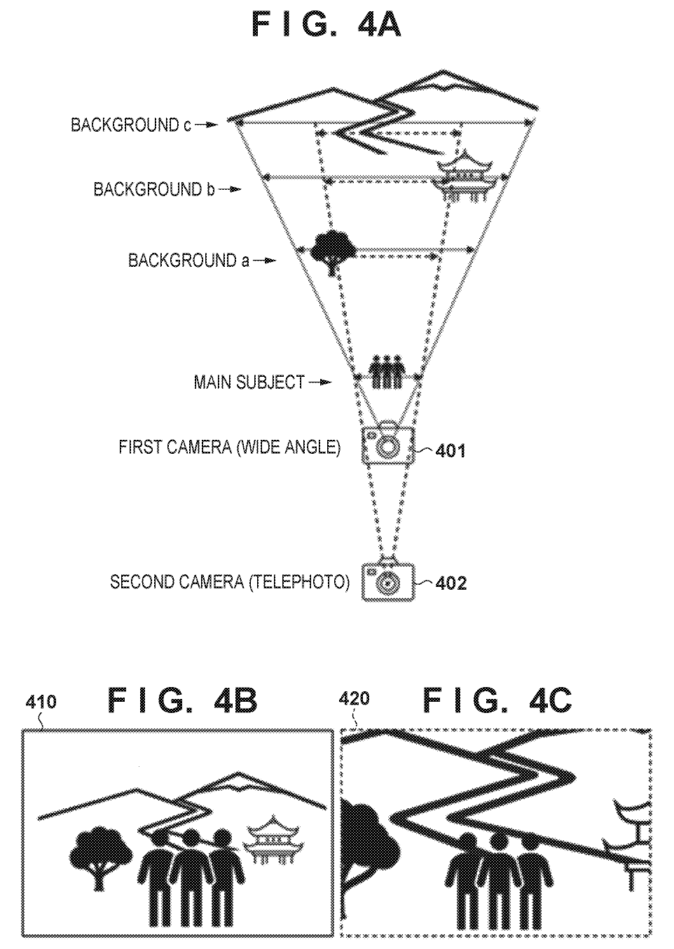

The perspectives of main subjects and backgrounds corresponding to the distances from the camera will be described next with reference to FIGS. 4A to 4C.

FIGS. 4A to 4C exemplarily show a scene where persons as main subjects are located in the center, a tree is located on the right side of a background, a building is located on the left side, and mountains are located in the back.

FIG. 4A exemplarily shows the distances from the cameras to the main subjects and the backgrounds. The example shown in FIG. 4A exemplarily shows a state in which a first camera 401 (wide angle) having a short focal length and a second camera 402 (telephoto) having a long focal length are arranged such that the main subjects are located at the same position with the same size in the images respectively shot by the first and second cameras.

FIGS. 4B and 4C exemplarily show the images obtained by shooting the main subjects and the backgrounds with the first camera 401 and the second camera 402 in FIG. 4A. FIG. 4B exemplarily shows an image 410 shot with the first camera 401 (wide angle) having a short focal length in the state shown in FIG. 4A. FIG. 4C exemplarily shows an image 420 shot with the first camera 402 (telephoto) having a long focal length in the state shown in FIG. 4A. The shot images 410 and 420 include main subjects, a tree as a background a, a building as a background b, and mountains as a background c.

The perspective of an image, that is, a phenomenon in which "nearby objects look large, and distant objects look small" will be described below with reference to FIGS. 4A to 4C.

In a case where the main subjects are shot by the first camera 401 in FIG. 4A, the angle of view of the lens having a short focal length spreads along the optical axis of the first camera 401 as indicated by the solid lines. Enhancing the perspective will create the image shown in FIG. 4B in which the nearby objects (subjects) look larger, and the distant objects look smaller.

In contrast to this, in a case where the main subjects are shot by the second camera 402 in FIG. 4A, the angle of view of the lens having a long focal length is small, spreading along the optical axis of the second camera 402 as indicated by the broken lines. As the focal length of the lens decreases, the difference in apparent size between nearby object and distant objects decrease, resulting in an image looking compressed with reductions in perspective of the main subjects and the background, as shown in FIG. 4C. The image shown in FIG. 4C is called an image with a compression effect. As the focal length changes, the distances to the backgrounds a, b, and c in FIG. 4A change based on the lens, and hence the senses of distances between the main subjects and the background a, between the background a and the background b, and between the background b and the background c can also be regarded to change.

### IMAGES WITH DIFFERENT PERSPECTIVE

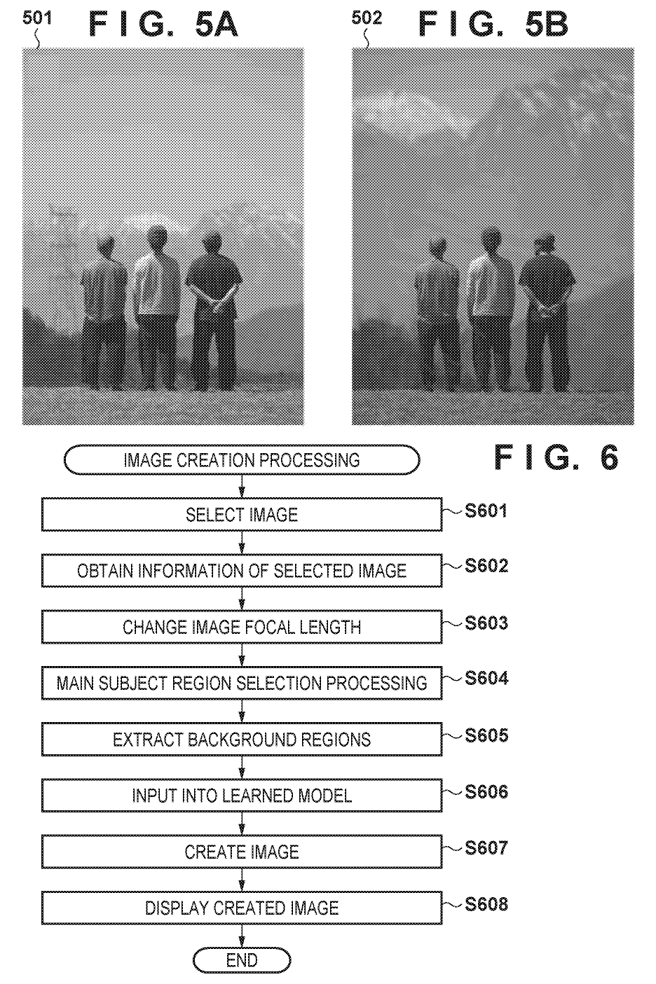

As described with reference to FIGS. 4A to 4C, FIGS. 5A and 5B exemplarily show images shot upon changing the focal length so as to make the size of the main subjects and the positional relationship unchanged.

FIGS. 5A and 5B exemplarily show, in a comparable manner, an image 501 shot on the wide-angle side with a short focal length and an image 502 shot on the telephoto side with a long focal length. The image 501 shot on the wide-angle side with the short focal length is an image with enhanced perspective, with the persons as the main subjects becoming larger, and the distant objects such as the mountains and the steel tower appearing in the background becoming smaller. In contrast to this, the image 502 shot on the telephoto side with the long focal length is an image having reduced perspective and a compression effect, with the steel tower disappearing from the background and the mountains becoming closer to the subjects.

Obviously, as described above, changing the focal length of the lens will change the sizes of background regions and the positional relationship without changing the size of the main subject, thereby creating an image with different perspective.

### IMAGE CREATION PROCESSING

The processing of creating an image with different perspective according to the present embodiment will be described next with reference to FIG. 6.

FIG. 6 is a flowchart exemplarily showing the processing of creating an image having undergone a change in perspective with the focal length different from that of a shot image according to the present embodiment.

The processing shown in FIG. 6 is implemented by causing the CPU 201 of the image processing apparatus 100 to control the respective components shown in FIG. 2 by executing programs stored in the ROM 202 so as to operate as the functions 301 to 306 in FIG. 3.

The present embodiment exemplifies a case where the image processing apparatus 100 creates an image whose focal length is different from that of an image shot by the image capture apparatus 102 and has undergone a change in perspective. However, the communication apparatus 101 or the image capture apparatus 102 may execute the above processing.

The processing in FIG. 6 exemplifies the processing of creating an image having undergone a change in perspective in a case where an image with a short focal length (for example, 100 mm) is changed into an image with a long focal length (for example, 300 mm).

In step S601, the CPU 201 selects an image to be processed from the images stored in the storage 204 of the image processing apparatus 100. In the present embodiment, the wide-angle image 410 with a short focal length in FIG. 4B is selected.

In step S602, the CPU 201 obtains image-related information necessary to create an image with different perspective from the meta data attached to the image selected in step S601. The image-related information includes information such as a focal length, shooting distance, subject, shooting position, and F-number.

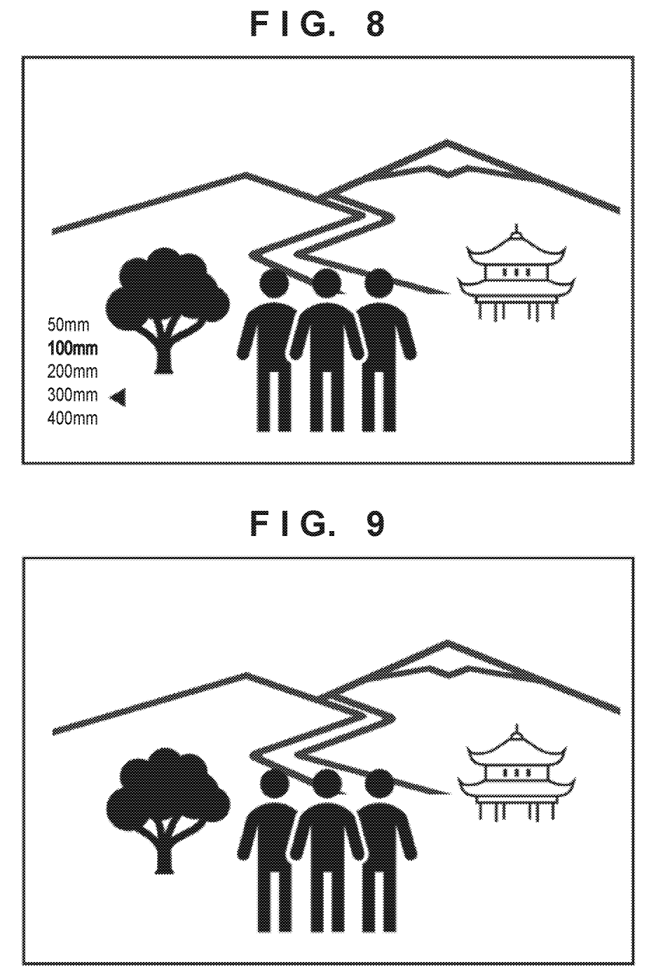

In step S603, the CPU 201 changes the focal length setting of the image selected in step S601. FIG. 8 exemplarily shows the image shot with a focal length of 100 mm and a user interface (UI) screen for changing the focal length setting. Focal length 100 mm at the time of shooting is displayed by boldface at the lower left part of the screen in FIG. 8, and the alternative focal lengths are displayed above and below focal length 100 mm. In the case shown in FIG. 8, a triangular arrow is displayed to change the focal length to focal length 300 mm. In this manner, the user can change the focal length setting by selecting a focal length to which the current focal length is to be changed on the UI screen. Assume that in the present embodiment, a long focal length of 300 mm has been selected.

In the case shown in FIG. 8, although the focal length set in step S603 is selected, the focal length may be changed by direct input to the application in the image processing apparatus 100. Alternatively, a focal length may be input via the application 311 in the communication apparatus 101 or the UI display unit 312 in FIG. 3 or may be input via the UI display unit 322 of the image capture apparatus 102.

In step S604, the CPU 201 selects main subjects.

Main subjects are selected based on a focus detection result, and shot subjects become main subjects. Alternatively, main subjects may be selected based on the main subject detection result set at the time of shooting. In a case where the subject detection setting in the camera indicates animals, a focused animal becomes a main subject based on a detection result. In a case where the subject detection setting indicates vehicles, a focused vehicle becomes a main subject.

In the case shown in FIG. 11, a focus detection region overlaps persons in the center, and three persons are detected as main subjects 1101. In this case, the three persons at the same distance are extracted as a main subject region. The main subjects may include a region 1102 closer than the main subjects 1101. This is because, since a compression effect is obtained from the positional relationship between a main subject and a background, a region located closer than the main subject can sufficiently obtain a compression effect without any change in the focal length of the image. In the case shown in FIG. 11, the main subjects 1101 and the region 1102 located closer than the main subjects are surrounded by the dotted line as a subject detection region. Note that the dotted line surrounding the main subjects 1101 may be extracted as a shape conforming to the contour of the subjects, or the contour of each subject may be extracted more precisely by performing segmentation and the like with respect to persons as main subjects.

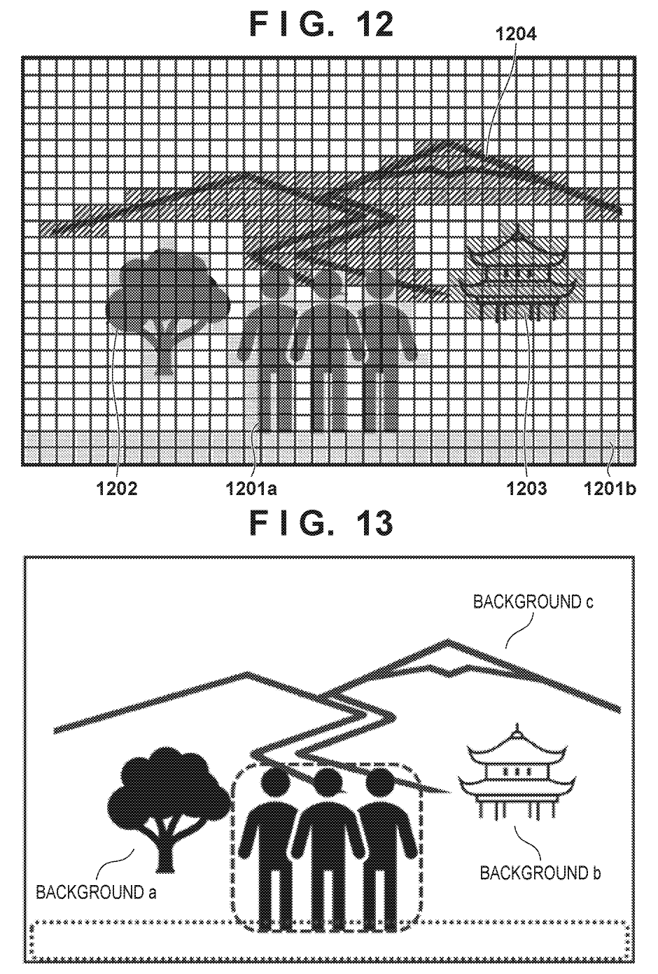

A method of selecting a main subject region using a defocus map will be described below with reference to FIG. 12.

FIG. 12 exemplarily shows a defocus map that converts the main subjects and the backgrounds in the image into shooting distance information.

Although FIG. 12 exemplarily shows the defocus map in a lattice pattern of 36x 25, the defocus map need not have a lattice pattern and may be displayed in a more segmented pattern.

The defocus map in FIG. 12 displays main subjects 1201a and a main subject region 1201b in the increasing order of focal length, and the distance to each subject is calculated as a defocus amount.

The defocus map displays a tree in a rhombic pattern 1202, a building indicated by negatively sloped lines 1203, and mountains indicated by positively sloped lines 1204. The distances to the respective backgrounds are calculated as defocus amounts.

The defocus map has a table of focus positions and distances for each lens and hence allows calculation of distances from defocus amounts. Accordingly, it is possible to calculate the distances to the subjects and the distances to the respective backgrounds in each defocus map from defocus amounts and focus position in the defocus map.

In selecting a main subject region, the distance to the main subjects and a region at distance shorter than the main subjects are calculated. In the defocus map shown in FIG. 12, the main subjects 1201a, a region located at the same focal length as the main subject region 1201b, and a region located closer than the main subjects 1201a are selected as a main subject region.

As another setting method for a main subject region, an object located at focus position 0 in a defocus map is a main subject, and a permissible circle of confusion range set based on the main subject may be set as a main subject region.

The permissible circle of confusion range corresponds to the range obtained by normalizing defocus amounts (mm) with F-numbers and is defined as Fδ. Fδ represents the value obtained by multiplying the open F-number of the lens by δ (0.02 mm).

Fδ represents the value obtained by conversion with defocus amount x F-number x δ (0.02 mm) = Fδ. For example, 1Fδ of an F2.8 lens is 1 x 2.8 x 0.02 = 0.056 mm.

Defocus amounts up to 0.056 mm may be regarded to fall within an allowable range, and all regions located in the minus direction from 0.056 mm in the plus direction of a main subject may be regarded as main subject regions.

The above defocus range of main subject regions is an example, and the value of δ can be arbitrarily changed.

Although the user may select a main subject and main subject regions with respect to the image processing apparatus 100, regions at distances shorter than the distance to the selected main subject are selected as main subject regions. Since a selected main subject region is excluded at the time of image creation, an image is created upon changing only the background regions without increasing the angle of view and changing the angle of view of the main subject region. Although not shown, laser light may be applied from an imaging surface position by using a distance sensor such as a LiDAR (Light Detection And Ranging) to set the result obtained by measuring the distance to a target object, the shape of the target object, and the like based on the information of the reflected light.

In step S605, the CPU 201 extracts regions other than the main subject region selected in step S604 as background regions.

FIG. 13 exemplarily shows the background regions other than the main subject region (other than the region indicated by the dotted line). In the case shown in FIG. 13, the background regions include the plurality of background regions including the region a of the tree, the region b of the building, and the region c of the mountains.

In step S606, the CPU 201 inputs the image selected in step S601, the focal length and distance information obtained from the meta data attached to the image, the focal length set in step S603, the main subject region selected in step S604, the background regions extracted in step S605, and other image-related information necessary for creation into a learned model having undergone learning processing (to be described later with reference to FIG. 7).

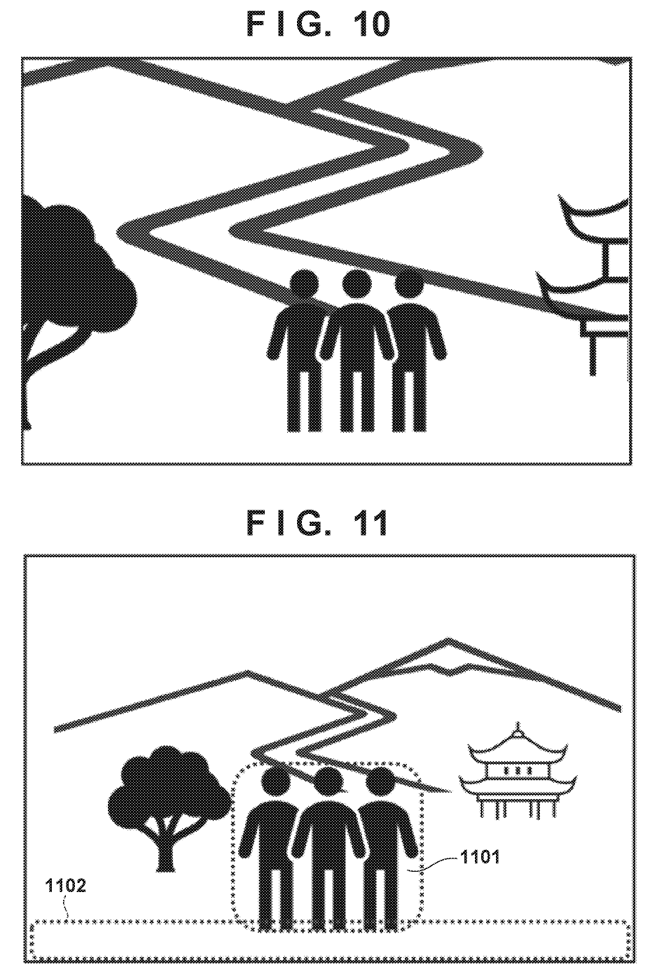

In step S607, the CPU 201 creates an image with different perspective upon changing the focal length with respect to the image selected in step S601. The image shown in FIG. 10 with long focal length and reduced perspective is created from the image shown in FIG. 9 with short focal length and enhanced perspective.

In step S608, the CPU 201 displays the image with different perspective created in step S607 on the display unit 207 and terminates the processing.

Note that an image with different perspective may be displayed on the UI display unit 312 of the communication apparatus 101 or on the UI display unit 322 of the image capture apparatus 102.

The present embodiment has exemplified the case where an image having a compression effect with long focal length and reduced perspective is created from an image with short focal length and enhanced perspective. In contrast to this, it is possible to create an image with short focal length and enhanced perspective by inputting an image with long focal length as input data to a learned model having undergone learning processing using an image with short focal length as training data and performing inference processing on the input data.

### LEARNING PROCESSING

The learning processing performed by the image processing apparatus 100 according to the present embodiment will be described next with reference to FIG. 7.

FIG. 7 exemplarily shows the learning model used for learning processing and the input/output data to/from the learning model according to the present embodiment.

The inference unit 306 inputs original image data 701, image-related information 702, and focal length change information 703 to the learning model 705 including a neural network to create image data (inference data) with different perspective from the original image data 701.

In the present embodiment, for example, the image 501 with enhanced perspective in FIG. 5A is the input data, and the image 502 with reduced perspective in FIG. 5B is the inference data. In contrast to this, the image 502 with reduced perspective can be input data, and the image 501 with enhanced perspective can be inference data.

The original image data 701 is, for example, the image shown in FIG. 9 with a focal length of 100 mm. The image-related information 702 includes the meta data attached to the original image data 701, the main subject region, and the background regions. In the present embodiment, input data includes image data, focal length, distance information, main subject region, and background regions. A main subject region and a background region are discriminated by annotating the images of input data and training data in advance. Annotation is performed in each image by discriminating which is a main subject and discriminating a region before the main subject as a main subject region. The distances to background regions other than the main subject region and the like may be calculated based on distance information such as a defocus map, GPS, and LiDAR.

Although not shown, an image with perspective may be created by inputting an F-number and creating blur associated with the set F-number based on the optical information of the lens. In this case, an image with the changed F-number is prepared as training data.

In the focal length change information 703, an instruction to change the focal length of the original image data 701 to 300 mm is set as input data.

Training data for learning will be described next. Training data 704 is, for example, an image with a focal length of 300 mm shown in FIG. 10. The training data 704 is an image with no change in the angle of view of the main subject region (with no change in the position and size of the main subject region) and a change in focal length with respect to the original image data 701.

The learning data creating unit 304 of the image processing apparatus 100 optimizes the learning model 705 by repeating parameter adjustment based on the above input data and training data. Inference data 706 with different perspective is created as a result of learning processing. Parameter adjustment for the learning model is repeated until an optimal result is obtained in comparison with the training data 704. When a learning model with optimized parameters is created, the processing is terminated. Note that publicly available images may be used for input data and training data via the Internet 103 or images usually shot by the user may be added afterward. As the number of images used for learning increases, a learning model with higher inference accuracy is obtained.

In learning processing, for example, in order to change the background of an image with a focal length of 100 mm into the background of an image with a focal length of 300 mm, the parameters of the respective background positions (the tree of the background a, the building of the background b, and the mountains of the background c) are adjusted, as shown in FIG. 13. For example, as indicated by the image shown in FIG. 10 as training data, parameter adjustment is repeated to set the background positions relative to the main subjects to the positions in the compressed image with reduced perspective.

The present embodiment has exemplified the learning processing for changing the image with a short focal length (for example, 100 mm) into the image with a long focal length (for example, 300 mm). However, it is possible to learn image data with a long focal length of 300 mm by using an image with a short focal length of 100 mm as training data. Repeatedly adjusting the parameters of a learning model so as to create image data with a short focal length from image data with a long focal length will create the positions and sizes of backgrounds so as to create the image shown in FIG. 9 with a focal length of 100 mm from the image shown in FIG. 10 with a focal length of 300 mm. In this case, in the example of FIG. 10, although the tree, the building, and the mountain on the background are cut off, creating a tree, a building, and a mountain ridge as in the image shown in FIG. 9 serving as training data will adjust parameters so as to set the same background positions and sizes as those of the training data.

As has been described above, according to the present embodiment, it is possible to create a learning model that implements image creation processing capable of changing the perspective of an image.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-003695, filed January 9, 2025 which is hereby incorporated by reference herein in its entirety.

What is claimed is:

1. An image processing apparatus comprising:
an obtaining unit that obtains a first image shot at a first focal length;
an extraction unit that extracts a main subject region and a first background region from the first image; and
a creating unit that creates a second image including a second background region in a case where shooting is performed at a second focal length different from the first focal length based on the first background region and distance information obtained from the first background region.

2. The apparatus according to claim 1, wherein the extraction unit selects a focus detection region or a subject detection region of the first image as the main subject region.

3. The apparatus according to claim 1, wherein the extraction unit extracts the main subject region and the first background region based on distance information obtained from a defocus map or a distance sensor.

4. The apparatus according to claim 2, wherein the main subject region includes a main subject and a region closer than the main subject.

5. The apparatus according to claim 1, wherein the extraction unit selects the main subject region based on a user operation.

6. The apparatus according to claim 1, wherein the first focal length is longer than the second focal length.

7. The apparatus according to claim 1, wherein the first focal length is shorter than the second focal length.

8. The apparatus according to claim 1, wherein the creating unit creates the second image by inputting the first image, related information of the first image, and focal length change information to a learned model.

9. The apparatus according to claim 8, wherein the related information includes a focal length, a shooting distance, a main subject region, and a background region.

10. The apparatus according to claim 8, wherein the learned model uses an image and related information of the image as input data and learns, as training data, an image with no change in angle of view of a main subject region of the related information and a change in focal length.

11. The apparatus according to claim 8, wherein the related information includes optical information of a lens, and
the learned model uses an image and related information of the image as input data and learns an image based on optical information after a change as training data.

12. An image processing method executed by an image processing apparatus comprising:
obtaining a first image shot at a first focal length;
extracting a main subject region and a first background region from the first image; and
creating a second image including a second background region in a case where shooting is performed at a second focal length different from the first focal length based on the first background region and distance information obtained from the first background region.

13. A non-transitory computer-readable storage medium storing a program for causing a computer to function as an image processing apparatus comprising:
an obtaining unit that obtains a first image shot at a first focal length;
an extraction unit that extracts a main subject region and a first background region from the first image; and
a creating unit that creates a second image including a second background region in a case where shooting is performed at a second focal length different from the first focal length based on the first background region and distance information obtained from the first background region.
